(19) United States
(12) Patent Application Publication
(10) Pub. No.: US 2026/0217567 A1
(43) Pub. Date: Jul. 30, 2026

(54) WATER DISTILLATION SYSTEM AND METHOD

(71) Applicant: James L. Orrington, II, Flossmoor, IL (US)

(72) Inventor: James L. Orrington, II, Flossmoor, IL (US)

(21) Appl. No.: 19/303,794

(22) Filed: Aug. 19, 2025

Related U.S. Application Data
(60) Provisional application No. 63/750,765, filed on Jan. 28, 2025.

(51) Int. Cl. C02F 1/00; B01D 3/02; B01D 5/00; C02F 1/04; C02F 1/30; C02F 1/36

(52) U.S. Cl. CPC C02F 1/005; B01D 3/02; B01D 5/006; B01D 5/0072; B01D 5/009; C02F 1/003; C02F 1/043; C02F 1/30; C02F 1/36

(57) ABSTRACT

Described herein are water distillation systems comprising a heating system for heating a liquid to a vapor, a cooling system for condensing the vapor to distilled water, a collection container for receiving and storing distilled water, and an energy generator for delivering energy to the distilled water to structure the distilled water into a “coherent domain.” The heating system may include a heating tank for storing a liquid and a heating element. The heating tank and heating element may be operatively connected with one another. The cooling system may be operatively connected with the heating tank and the collection container. The energy generator may include a sound generator and/or a light device. The collection container may be positioned adjacent to the energy generator. Using the systems described herein, the distilled water receives sound energy and/or electromagnetic energy. Also described herein are methods for distilling water using the systems described herein.

### CROSS-REFERENCE TO RELATED APPLICATION

This application claims the benefit of the filing date of Provisional Application Ser. No. 63/750,765, filed on Jan. 28, 2025.

### FIELD OF THE INVENTION

The present disclosure relates generally to a water distillation system for

removing impurities and contaminants from a liquid, and more particularly, relates to a water distillation system for producing structured distilled water.

### BACKGROUND

Water is essential for maintaining our world. It touches every aspect of daily living, from drinking, cooking, sanitation, and agriculture. However, the supply of usable water (i.e., freshwater) is limited because the vast majority of Earth's water is saltwater found in the oceans, making up around 97% of the total water supply. The amount of available freshwater is further limited in that most of the freshwater is contained within glaciers and ice caps, leaving a very small percentage readily available for human use.

With the limited amount of fresh water available for human use, contamination of the water supply with harmful chemicals is a significant concern because these chemicals can have detrimental effects on a person's health. The chemicals may increase the risk of cancer, liver damage, infertility, and other deleterious health effects. Examples of harmful chemicals commonly found in water include lead, arsenic, nitrate, mercury, copper, chlorine, radioactive substances, and PFAS (per- and polyfluoroalkyl substances). PFAS are often referred to as “forever chemicals” due to their persistence in the environment. PFAS can be particularly dangerous when present in drinking water.

Although current water purification methods address contamination issues by removing contaminants from water, these methods fail to address an important aspect of water that significantly impacts health: the coherency or structure of water, which is referred to and known by those skilled in the art as the coherent domain.

Coherent water or coherent domain (i.e., structured water) provides significant benefits for both health and the environment, making it a key component for sustainable living. On a cellular level, coherent water has been shown to increase cellular energy production and hydration, leading to improved vitality and overall health. What is needed is a system for generating coherent or structured water for drinking and otherwise for day-to-day activities for which water is typically used by humans.

Structured water may help a person's body absorb nutrients and stay hydrated because water carries electrolytes into a cell. Structured water may help a human's or animal's immune system function properly by improving cell function and detoxifying the body from toxic chemicals.

### SUMMARY

Described herein are water distillation systems. One aspect of the present disclosure relates to a water distillation system for producing structured water that is free of contaminants and undesired materials. The water distillation system may be configured to use sound and electromagnetic waves to organize distilled water into a coherent domain. This energy can be described by frequency, wavelength, or energy.

Water distillation systems according to this disclosure may include a heating system for heating a liquid to a vapor, a cooling system for condensing the vapor to distilled water, a collection container for receiving and storing distilled water, and an energy generator for delivering energy to the distilled water to structure the distilled water into a “coherent domain.” Heating systems as described herein may include a heating tank for storing a liquid and a heating element configured to radiate thermal energy. The heating tank and heating element may be operatively connected with each other, and may be thermally connected with each other. Cooling systems as described herein may be operatively connected with the heating tank and the collection container. The energy generator may be configured to emit sound energy directed at the collection container housing distilled water. The distilled water may receive the sound energy as the collection container is positioned adjacent to the energy generator.

According to an alternative embodiment, a water distillation system may include a heating system for heating a liquid to a vapor, a cooling system for condensing the vapor to distilled water, a collection container for receiving and storing distilled water, and an energy generator for delivering energy to the distilled water to structure the distilled water into a “coherent domain.” The heating system may include a heating tank for storing a liquid and a heating element configured to radiate thermal energy. In an embodiment, the heating tank and heating element may be operatively connected with one another. The cooling system may be operatively connected with the heating tank and the collection container. The energy generator may be configured to emit electromagnetic energy directed at the collection container housing the distilled water. The distilled water may receive electromagnetic energy due to the positioning of the collection container adjacent to the energy generator.

According to an alternative embodiment, water distillation systems as described herein may include a heating system for heating a liquid to a vapor, a cooling system for condensing the vapor to distilled water, a collection container for receiving and storing distilled water, and an energy generator for delivering energy to the distilled water to structure the distilled water into a “coherent domain.” The heating system may include a heating tank for storing a liquid and a heating element configured to radiate thermal energy. The heating tank and heating element may be operatively, including thermally, connected with one another. The cooling system may be operatively connected with the heating tank and the collection container. The energy generator may include a sound generator configured to emit sound energy and/or a light device configured to emit electromagnetic energy directed at the collection container housing the distilled water. The distilled water receives electromagnetic energy due to the positioning of the collection container adjacent to the energy generator.

### BRIEF DESCRIPTION OF THE DRAWINGS

FIG. 1 shows a front-right perspective view of a water distillation system, according to an embodiment of this disclosure.

FIG. 2 shows a front-left perspective view of a water distillation system, according to an embodiment of this disclosure.

FIG. 3 shows an exploded view of a water distillation system, according to an embodiment of this disclosure.

FIG. 4 shows an exploded view of a heating system, according to an embodiment of this disclosure.

FIGS. 5A and 5B show the components of a filtration system, according to an embodiment of this disclosure.

FIGS. 6A, 6B, and 6C show components of an energy generator for a water distillation system, in accordance with one or more embodiments of the disclosure.

FIG. 7 shows a flow chart setting forth the steps of a method for distilling water using systems described herein.

### DETAILED DESCRIPTION

The following detailed description refers to the accompanying drawings. The same reference numbers in different drawings may identify the same or similar elements.

As used herein, the term “coherent domain” refers to a cluster of water molecules that oscillate in unison, maintaining a synchronized state within a self-trapped electromagnetic field. This energy can be described by frequency, wavelength, sound, or energy. The coherent domain essentially acts as a small, organized region within the larger body of water. In other words, the water molecules form a liquid crystalline structure by bonding together. When water molecules are bound together in a liquid crystalline structure, the water is said to be coherent or structured.

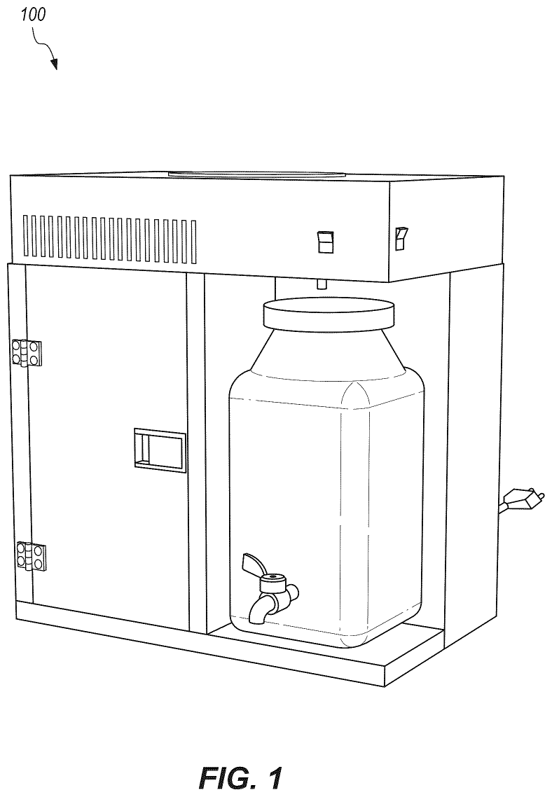

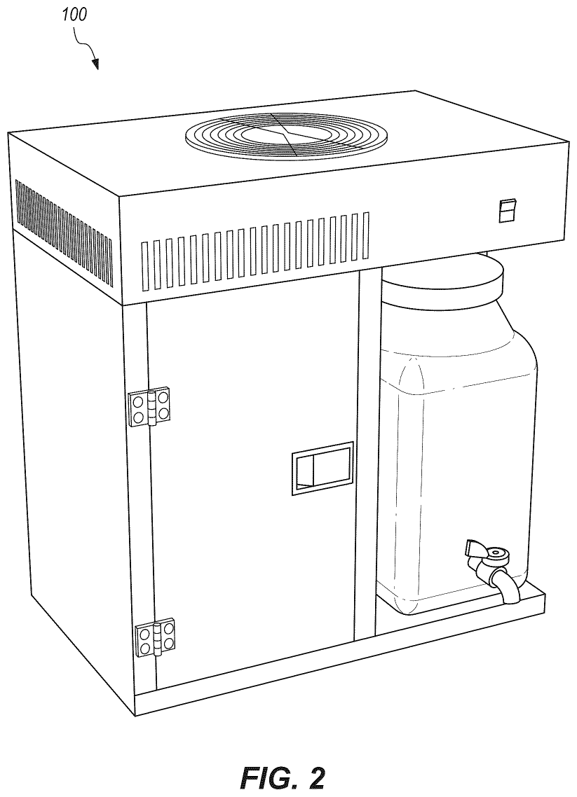

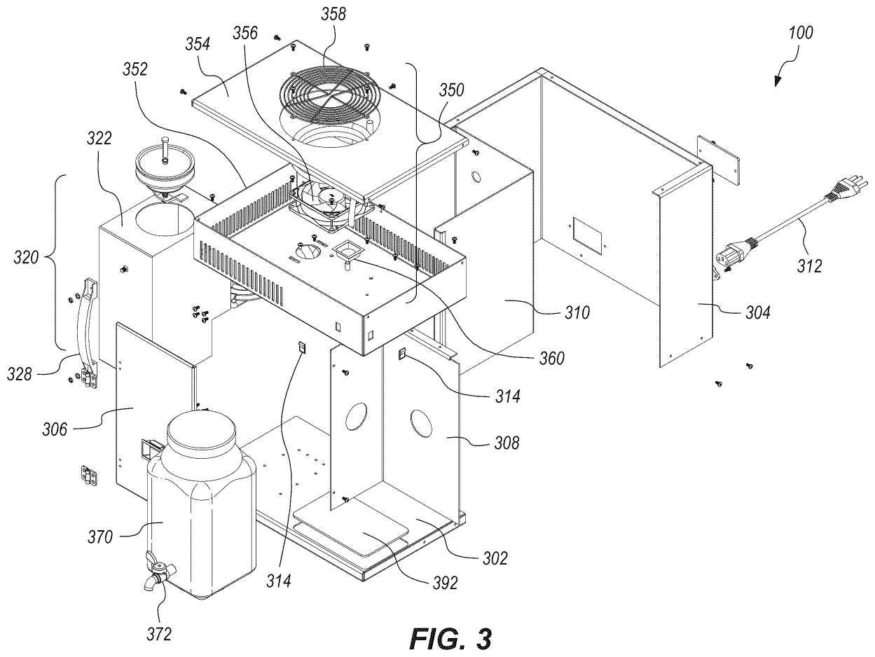

FIGS. 1 and 2 show perspective views of a water distillation system 100, according to one or more embodiments of the disclosure. As shown in FIGS. 1 and 2 and illustrated in greater detail in FIG. 3, which constitutes an exploded view of a water distillation system according to embodiments of this disclosure, water distillation systems enabled by this disclosure may comprise a heating system 320 for heating and converting a liquid into a vapor, a cooling system 350 for cooling and condensing the vapor into distilled water, a collection container 370 for collecting the distilled water, and an energy generator for structuring the distilled water into a “coherent domain.”

In an embodiment, water distillation systems enabled by this disclosure may exhibit a distilling rate of one liter per hour.

In an embodiment, water distillation systems enabled by this disclosure may have a weight of between 5 kilograms and 25 kilograms, without limitation.

The water distillation systems described herein may be virtually any size that is conducive either to positioning of the system within a residence or in commercial office building. By way of example only, in one embodiment, the water distillation system may be between 24 and 40 centimeters in width, 35 and 55 centimeters in height, and between 22 and 32 centimeters in depth.

The water distillation systems described herein may be made of any durable, water resistant, and heat resistant material that does not compromise the functionality of the system. In an embodiment, the system may be made of stainless steel. In another embodiment, the system may be made of polypropylene.

The water distillation system 100 further includes a base 302 to support the heating system 320 and the collection container 370, an outer case 304 for enclosing the heating system 320 and the collection container 370, and an access door 306 for providing access to the heating system 320. A middle divider 308 separates the heating system 320 and the collection container 370.

The heating system 320 may be further enclosed by a heating tank liner 310 configured to operate as an insulator to reduce thermal energy loss to the environment of the water distillation system 100. The heating tank liner 310 may be made from materials such as polyethylene, polypropylene, polyurethane, butyl rubber, EPDM material, or a combination thereof. In an embodiment, the capacity of the heating tank may be between approximately two liters and five liters, without limitation.

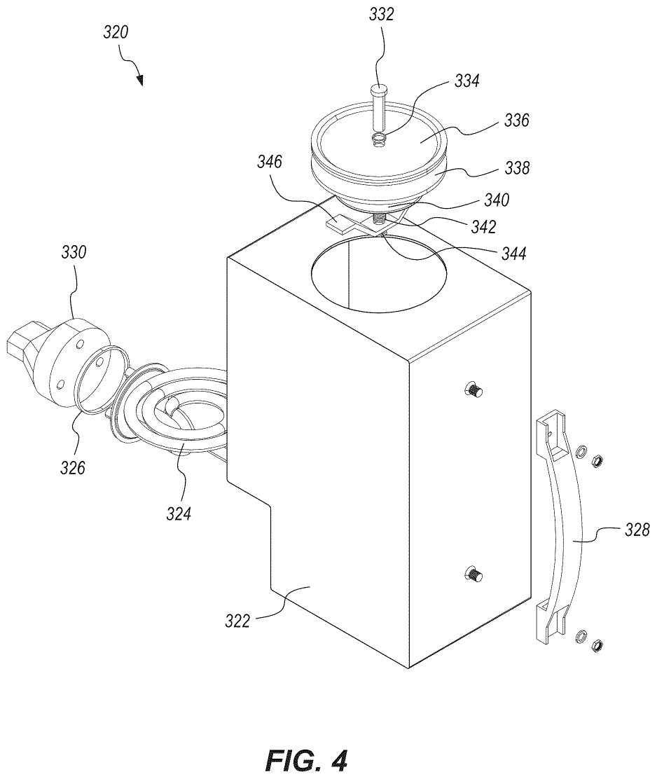

The heating system 320, shown in greater detail in FIG. 4, may include a heating tank 322 for holding a liquid and a heating element 324 for converting the liquid into a vapor. The heating system 320 may be configured to release the vapor contained within the heating tank 322. Once released, the vapor may be fed into the cooling system 350 for condensing the vapor to distilled water.

The cooling system 350 may include a top cabinet 352 and a top cover 354, where the top cabinet 352 and the top cover 354 form an enclosure for containing the vapor released from the heating system 320. The cooling system 350 may further include a vent 358 in the top cover 354 and a fan assembly 356 positioned within the enclosure. The vent 358 and fan assembly 356 may be isolated from the vapor contained within the cooling system 350. The fan assembly 356 may be configured to cool the vapor by propelling the heated air, caused by the vapor, through the vent 358 to the outside of the water distillation system 100.

As the vapor cools, the vapor condenses into distilled water. The distilled water is filtered through the filtration system, as discussed further below. The distilled water exits the filtration system and is fed into the collection container 370. The distilled water may be fed into the collection container in any manner that is effective in transporting the water into the container and does not compromise the structural integrity and/or chemical composition of the water. In an embodiment, the distilled water may be fed into the collection container through a water tap. The water tap may, without limitation, be made of stainless steel, gold, and/or silver.

The collection container 370 may be configured for storing the distilled water. The collection container 370 may be removable. The collection container 370 may be made of glass, plastics free of bisphenol-A (BPA), stainless steel, gold, silver, or palladium, without limitation.

The collection container 370 may include spout 372 for dispensing the distilled water from the collection container 370. The spout 372 may be made of gold, zinc, stainless steel, palladium, silver, and/or other durable materials. In an embodiment, the collection container may not include a spout 372.

Once the distilled water is stored in the collection container 370, the energy generator may emit sound energy (i.e., sound waves), electromagnetic energy (i.e., electromagnetic waves), or a combination thereof to the collection container 370. The sound waves and/or electromagnetic waves interact with molecules of the distilled water, causing the distilled water molecules to organize themselves in a coherent domain.

FIG. 4 shows an exploded view of the heating system 320 of FIGS. 1, 2, and 3. The heating system 320 may be configured to heat a liquid and convert it into vapor by applying thermal energy in the form of heat to a liquid housed within the heating system 320.

The heating system 320 may include a heating tank 322 for storing the liquid and a heating element 324 for heating the liquid housed within the heating tank 322. The heating tank 322 and the heating element 324 may be operatively connected, including thermally connected, where the heating element 324 radiates thermal energy that is received by the heating tank 322. As the heating tank 322 houses the liquid, the heating tank 322 transmits the thermal energy to the liquid. As a result, the temperature of the liquid increases, resulting in a portion of the liquid being converted to vapor. In some embodiments, when liquid is heated for an extended time period, all of the liquid may be converted to vapor, leaving residue in the heating tank 322. The residue may contain contaminants and unwanted materials, such as pathogens.

The heating element 324 may be configured to receive and convert an electric current into thermal energy. The heating element may be operatively connected with a power source. In an embodiment, the heating element 324 may be electrically connected to a power source via a power cord 312. In other embodiments, the heating element 324 may be electrically connected to a power source independent of an electrical grid, such as batteries and/or generators. When in operation, the water distillation systems enabled by this disclosure may, in some non-limiting embodiments, utilize 700-1,500 watts of power and may have an operating voltage of between 100 and 300 voltz.

As the heating tank 322 may be removable from the water distillation system 100, in some embodiments the heating tank 322 may include a handle 328 to facilitate removing, and connecting and disconnecting, the heating tank 322. Once the heating tank 322 has been removed, liquid may be added to the heating tank 322. In another embodiment, the liquid may be added to the heating tank 322 while the heating tank 322 remains connected to the water distillation system 100.

The heating system 320 may further include a heating element kit 330 configured to regulate the heating element 324. For example, the heating element kit 330 may regulate the amount of thermal energy supplied by the heating element 324. The heating system 320 may further include an O-ring element 326 to reduce the loss of thermal energy to the environment.

The heating tank 322 may include additional elements, such as a lid knob 332, lid O-ring 334, lid disk 336, gasket 338, washer 340, lid spring 342, boiling assembly 344, and crossbar 346. These additional elements cooperatively operate to seal the heating tank 322 from evaporation of the liquid when the water distillation system 100 is not being used. When the water distillation system 100 is in use, the lid disk 336 may be separated from the heated tank to allow the vapor to escape into the cooling system 350 from the heated tank. Lid separation may occur when pressure exceeds the force of the lid spring configured to maintain the seal to prevent evaporation of the liquid.

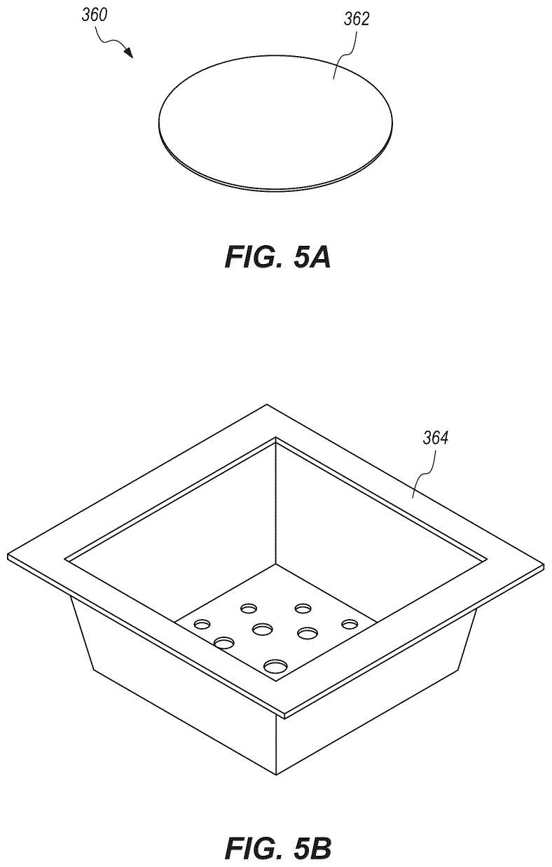

FIGS. 5A and 5B show the components of a filtration system as described herein. After the cooling system 350 condenses the vapor into distilled water, the distilled water may be fed into the filtration system, which may be configured to remove contaminants or other unwanted materials that may have traveled with the vapor. The filtration system may include a filter cup 362 and one or more filters 364 housed with the filter cup 362. In some embodiments, the filter 364 may be a carbon filter. In an embodiment, the filter may be a replaceable active carbon filter.

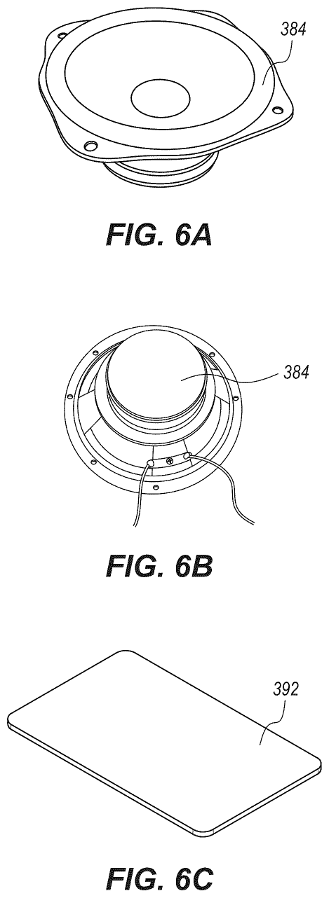

FIGS. 6A, 6B, and 6C show components of an energy generator for a water distillation system 100, in accordance with one or more embodiments of this disclosure. The energy generator may include a sound generator for transmitting sound energy and a light device for transmitting electromagnetic energy to the collection container 370 holding distilled water.

The sound generator may include one or more speakers 384 and a wireless transmitter configured to communicate with a sound software application (i.e., tone sound generator) operating on a server or a user device (e.g., laptop, mobile phone, tablet), which device may be operating through an iOS or Android software platform, without limitation. The speakers 384 may be configured to generate sound energy (i.e., sound waves). The sound software application allows users to control the frequencies and amplitudes of the sound waves emitted from the speakers 384. In some embodiments, the sound software application may be communicatively connected with the water distillation system using Bluetooth technology, without limitation. In some embodiments such communicative connectively may be realized through a network, such as the internet. Alternatively, in some embodiments, the frequencies and amplitudes of the sound waves emitted from the speakers 384 may be controlled through conventional control units located on the system such as, for example, a button(s) or a swtich(es).

The speakers 384 may emit sound waves in musical tone, with mode and frequencies, such as sub-bass, bass, low midrange, midrange, high midrange, presences with instruments, and brilliance. Examples of frequencies that the speakers may emit include, without limitation, 396 HZ, 963 HZ, 693 HZ, and 852 HZ; as well as Theta, Beta, Delta, Gamma, and Alpha.

The speakers 384 may be positioned in proximity to the collection container 370 via the opening of the middle divider 308, as shown in FIG. 3. Based on the proximity of the middle divider 308 to the collection container 370, the speakers 384 may be in physical contact with the collection container 370 or in close proximity. When in operation, the speakers 384 may transmit sound energy to the collection container 370, where the sound energy propagates through the collection container 370 to the distilled water housed in the collection container 370. The distilled water interacts with the sound energy, structuring the distilled water in a “coherent domain.”

FIGS. 6A and 6B show an example of a speaker for the sound generator. Although speakers 384 are shown, the sound generator may use other devices to produce sound waves, such as a piezoelectric crystal within a transducer. A piezoelectric crystal within a transducer may be used in an ultrasound device to create sound waves by vibrating when an electrical current is applied to the piezoelectric crystal.

The light device may include a light source configured for transmitting energy to the collection container 370 in the form of electromagnetic waves. The light source may be positioned underneath the collection container 370, as shown in FIG. 3. The electromagnetic waves may include the wavelengths from the visible light spectrum (ranging 400 nm to 700 nm) and the non-visible light spectrum (e.g., infrared and ultraviolet).

The light device further includes a wireless transmitter configured to communicate with the light device and a light software application operating on a user device (e.g., laptop, mobile phone, tablet), which device may be operating through an iOS or Android software platform, without limitation. The light software application may be used to control the light device by changing the wavelength or frequency of the electromagnetic wave. A user may, therefore, change the type of visible lighting (e.g., red, blue, green). In some embodiments, the light software application may be communicatively connected with the water distillation system using Bluetooth technology, without limitation. In some embodiments such communicative connectively may be realized through a network, such as the internet. Alternatively, in some embodiments, the wavelength or frequency of the electromagnetic waves may be controlled through conventional control units located on the system such as, for example, a button(s) or a swtich(es).

FIG. 6C shows an example of a liquid-crystal display (LCD) 392 being used as a light source. Although an LCD 392 is shown, the light device may use other light sources to produce electromagnetic waves. Examples of other light sources suitable for use in connection with the systems described herein include a light-emitting diode (LED), organic light-emitting diode (OLED), halogen bulb, and/or fluorescent light bulb.

The light device transmits electromagnetic energy to the collection container 370, where the electromagnetic energy propagates through the collection container 370 to the distilled water housed in the collection container 370. The distilled water interacts with the sound energy, structuring the distilled water in a “coherent domain.”

The light device may transmit electromagnetic waves of a number of different wavelengths and/or frequencies. In an embodiment, the light device may transmit electromagnetic waves of alternating wavelengths and/or frequencies. In some embodiments, the light device may be operable in a plurality of different modes at the selection of a user. The pattern and/or sequence of electromagnetic wavelengths and/or frequencies of electromagnetic waves being emitted may differ from one mode to the next.

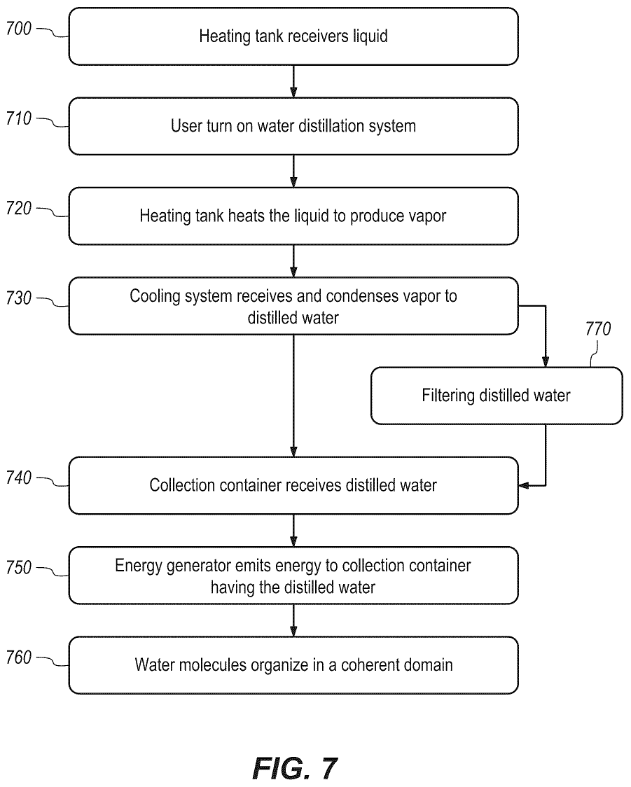

FIG. 7 provides a flowchart for one, non-limiting method of using an embodiment of a water distillation system 100 as described herein to distill water. At step 700, a user pours liquid into the water distillation system 100. According to this embodiment, the liquid is housed in a heating tank 322.

At step 710, the user turns on the water distillation system 100 via a power switch 314 to allow the water distillation system 100 to receive an electric current from a power source. Those skilled in the art will readily appreciate that in lieu of a power switch, any number of other control mechanisms may be used to modulate the power status of the system. In an embodiment, the power status of the system may be controlled via voice commands. In this embodiment, the system may comprise one or more sensors configured to detect the voice commands and, upon receipt of the voice command(s), transmit a command signal to a controller unit configured to modulate the power status of the system.

At step 720, a heating element 324 receives and converts the electric current into thermal energy (i.e., heat). The heating tank 322 absorbs the thermal energy radiating from the heating element 324. Since the heating tank 322 houses the liquid, the liquid also absorbs the thermal energy, resulting in a temperature increase in the liquid and a conversion of a portion of the liquid into a vapor.

At step 730, the vapor is fed into a cooling system 350 configured to receive and condense the vapor into distilled water. The cooling system 350 condenses the vapor into distilled water by cooling the vapor via the fan assembly 356 and the vent 358.

At step 740, the distilled water is fed into the collection container 370 for storage. The collection container 370 may be removable.

At step 750, once the distilled water is stored in the collection container 370, the energy generator emits sound energy (i.e., sound waves), electromagnetic energy (i.e., electromagnetic waves), or a combination thereof to the collection container 370. In an embodiment, the sound energy may comprise music.

At step 760, the sound waves and/or electromagnetic waves interact with the molecules of the distilled water, causing the distilled water molecules to organize themselves in a coherent domain.

At step 770, optionally, the distilled water may be fed through a filtration system prior to entering the collection container 370. The filtration system removes contaminants or unwanted material that may have traveled with the vapor through the cooling system 350. The filtration system includes a filter cup 362 and one or more filters 364. In one, non-limiting embodiment, the filter 364 may be a carbon filter.

Water distillation methods as contemplated herein, using water distillation systems enabled by this disclosure, may comprise providing a heating system that includes a heating tank configured to store a liquid and a heating element configured to radiate thermal energy, wherein the heating element is operatively connected with the heating tank. The methods may further comprise providing a cooling system operatively connected with the heating tank, wherein the cooling system may be configured to receive a vapor generated from a portion of the liquid receiving the thermal energy, and to condense the vapor into a distilled water. The methods may further comprise providing a collection container operatively connected with the cooling system, wherein the collection container may be configured to receive and store the distilled water. The methods may further comprise providing an energy generator configured to emit sound energy, wherein the energy generator may be positioned adjacent to the collection container such that the distilled water may receive the sound energy emitted from the energy generator.

In some embodiments, the water distillation systems described herein may further comprise sensors for determining the quantity of water in the collection container. Water distillation methods as described herein may further comprise a step of automatic cessation of the water distillation process when the sensors detect an amount of water in the collection container that falls below a pre-selected, user-defined threshold.

While various aspects have been described in the above disclosure, the description of this disclosure is intended to illustrate and not limit the scope of the invention. The invention will be defined by the scope of the claims and not the illustrations and examples provided in the above disclosure. Skilled artisans will appreciate additional aspects of the invention, which may be realized in alternative embodiments, after having the benefit of the above disclosure. Other aspects, advantages, embodiments, and modifications are within the scope of the invention as contemplated.

What is claimed is:

1. A water distillation system comprising:
a heating system including:
a heating tank configured to store water; and
a heating element configured to radiate thermal energy, wherein the heating element is thermally connected to the heating tank;
a cooling system operatively connected with the heating tank, wherein the cooling system is configured to receive a vapor generated from a portion of the water having received the thermal energy, wherein the cooling system is configured to condense the vapor into a distilled water;
a collection container connected operably to the cooling system, wherein the collection container is configured to receive and store the distilled water; and
an energy generator configured to emit sound energy, wherein the energy generator is positioned adjacent to the collection container,
wherein the distilled water receives the sound energy emitted from the energy generator.

2. The water distillation system of claim 1, further comprising a filtration system configured to filter the distilled water exiting the cooling system, wherein the filtration system includes a filter cup and one or more filters.

3. The water distillation system of claim 1, wherein the energy generator includes a sound generator having one or more speakers, wherein each speaker is configured to emit sound waves.

4. The water distillation system of claim 3, wherein the sound generator includes a wireless transmitter configured to communicate with the sound generator and a sound software application operating on a user device.

5. The water distillation system of claim 4, wherein the sound software application allows a user to control each speaker by modifying a musical tone of the sound waves.

6. The water distillation system of claim 1, wherein the collection container is made of glass, plastic without BPA, or a combination of thereof.

7. The water distillation system of claim 1, wherein the energy generator includes a light device having one or more light sources, wherein each light source is configured to emit electromagnetic waves, wherein the one or more light sources include a light-emitting diode (LED), an organic light-emitting diode (OLED), a halogen bulb, a fluorescent light bulb, or a combination thereof.

8. A water distillation system comprising:
a heating system including:
a heating tank configured to store water; and
a heating element configured to radiate thermal energy, wherein the heating element is operatively connected with the heating tank;
a cooling system operatively connected with the heating tank, wherein the cooling system is configured to receive a vapor generated from a portion of the water having received the thermal energy, wherein the cooling system is configured to condense the vapor into a distilled water;
a collection container operatively connected with the cooling system, wherein the collection container is configured to receive and store the distilled water; and
an energy generator configured to emit electromagnetic energy, wherein the energy generator is positioned adjacent to the collection container,
wherein the distilled water receives the electromagnetic energy emitted from the energy generator.

9. The water distillation system of claim 8, further comprising a filtration system configured to filter the distilled water exiting the cooling system, wherein the filtration system includes a filter cup and one or more filters.

10. The water distillation system of claim 8, wherein the energy generator includes a light device having one or more light sources, wherein each light source is configured to emit electromagnetic waves.

11. The water distillation system of claim 10, wherein the one or more light sources include a light-emitting diode (LED), an organic light-emitting diode (OLED), a halogen bulb, a fluorescent light bulb, or a combination thereof.

12. The water distillation system of claim 10, wherein the light device includes a wireless transmitter configured to communicate with the light device and a light software application operating on a user device.

13. The water distillation system of claim 12, wherein the light software application allows a user to control each of the one or more light sources by modifying the frequency of the electromagnetic wave.

14. The water distillation system of claim 13, wherein the collection container is made of glass, plastic without BPA, or a combination of thereof.

15. A water distillation system comprising:
a heating system including
a heating tank configured to store water; and
a heating element configured to radiate thermal energy, wherein the heating element operatively connected with the heating tank;
a cooling system operatively connected with the heating tank, wherein the cooling system is configured to receive a vapor generated from a portion of the water having received the thermal energy, wherein the cooling system is configured to condense the vapor into a distilled water;
a collection container operatively connected with the cooling system, wherein the collection container is configured to receive and store the distilled water; and
an energy generator including a sound generator configured to emit sound energy and a light device configured to emit electromagnetic energy, wherein the energy generator is positioned adjacent to the collection container; and
configured to emit electromagnetic energy directed towards the collection container, the energy generator comprising one or more light sources, wherein the energy generator is positioned adjacent to the collection container,
wherein the distilled water receives the electromagnetic energy emitted from the energy generator.

16. The water distillation system of claim 15, further comprising a filtration system configured to filter the distilled water exiting the cooling system, wherein the filtration system includes a filter cup and one or more filters.

17. The water distillation system of claim 15, wherein the energy generator includes a sound generator having one or more speakers, wherein each speaker is configured to emit sound waves.

18. The water distillation system of claim 17, wherein the sound generator includes a wireless transmitter configured to communicate with the sound generator and a sound software application operating on a user device, wherein the sound software application allows a user to control each speaker by modifying a musical tone of the sound waves.

19. The water distillation system of claim 18, wherein the light device includes a wireless transmitter configured to communicate with the light device and a light software application operating on a user device, wherein the light software application allows a user to control each light source by modifying the frequency of the electromagnetic wave.

20. The water distillation system of claim 19, wherein the collection container is made of stainless steel, gold, glass, plastic without BPA, or a combination of thereof.
